(19) United States
(12) Patent Application Publication
(10) Pub. No.: US 2023/0040982 A1
(43) Pub. Date: Feb. 9, 2023

(54) ATTACK INFORMATION PROCESSING APPARATUS, ATTACK INFORMATION PROCESSING METHOD, AND COMPUTER READABLE MEDIUM

(71) Applicants: NEC CORPORATION, Tokyo (JP); B. G. Negev Technologies and Applications Ltd., at Ben-Gurion University, Beer-Sheva (IL)

(72) Inventors: Masaki INOKUCHI, Tokyo (JP); Tomohiko YAGYU, Tokyo (JP); Asaf SHABTAI, Hulda (IL); Yuval ELOVICI, Arugot (IL); Ron BITTON, Yehud (IL); Hodaya BINYAMINI, Beer-Sheva (IL)

(73) Assignees: NEC CORPORATION, Tokyo (JP); B. G. Negev Technologies and Applications Ltd., at Ben-Gurion University, Beer-Sheva (IL)

(21) Appl. No.: 17/793,110

(22) PCT Filed: Jan. 17, 2020
(86) PCT No.: PCT/JP2020/001484

§ 371 Date: Jul. 15, 2022

(51) Int. Cl. G06F 21/57

(52) U.S. Cl. CPC G06F 21/577; G06F 2221/034

(57) ABSTRACT

An attack information processing apparatus (10) includes an extraction unit (11) configured to extract first and second attack knowledge pieces indicating conditions of a cyber attack from first and second attack information pieces including descriptions of the cyber attack, a determination unit (12) configured to determine similarity between the first and second attack information pieces, and a complementing unit (13) configured to complement the first attack knowledge piece with the second attack knowledge piece based on the determined similarity.

### TECHNICAL FIELD

The present disclosure relates to an attack information processing apparatus, an attack information processing method, and a non-transitory computer readable medium storing an attack information processing program.

### BACKGROUND ART

Recently, cyber attacks attacking vulnerabilities of computer systems have significantly increased and hence threats to cyber security have increased. Therefore, it is desired to cope with attack information related to vulnerabilities that are newly discovered every year or more often, even every day.

For example, Non-patent Literature 1 has been known as a related art. Non-patent Literature 1 discloses a technique for generating an attack graph based on information extracted from an NVD (National Vulnerability Database) which is a vulnerability information database. In Non-patent Literature 1, attack conditions are extracted from the NVD by using keyword matching and/or machine learning.

### CITATION LIST

### Non Patent Literature

Non-patent Literature 1: M. Ugur Aksu, Kemal Bicakci, M. Hadi Dilek, A. Murat Ozbayoglu, and E. Islam Tatli, “Automated Generation of Attack Graphs Using NVD”, The Eighth ACM Conference on Data and Application Security and Privacy (CODASPY '18), 2018, P. 135-142

### SUMMARY OF INVENTION

### Technical Problem

In the related art such as the technique disclosed in Non-patent Literature 1, attack conditions are extracted from attack information that is open to the public by using keyword matching and/or machine learning. However, there is a problem that when information is extracted as extracted in the related art, in some cases, it is difficult to obtain attack knowledge including attack conditions.

One of the objects of the present disclosure is to provide an attack information processing apparatus, an attack information processing method, and a non-transitory computer readable medium storing an attack information processing program, capable of obtaining more accurate attack knowledge.

### Solution to Problem

An attack information processing apparatus according to the present disclosure includes: an extraction unit configured to extract first and second pieces of attack knowledge (hereinafter also referred to as first and second attack knowledge pieces (including items, attributes, etc.)) indicating conditions of a cyber attack from first and second pieces of attack information (hereinafter also referred to as first and second attack information pieces) including descriptions of the cyber attack; a determination unit configured to determine similarity between the first and second attack information pieces; and a complementing unit configured to complement the first attack knowledge piece with the second attack knowledge piece based on the determined similarity.

An attack information processing apparatus according to the present disclosure includes: extraction means for extracting a plurality of attack knowledge pieces indicating conditions of a cyber attack from a plurality of attack information pieces including descriptions of the cyber attack; learning means for generating a learning model that has learned a relation between the plurality of attack information pieces and the plurality of attack knowledge pieces; and complementing means for complementing an attack knowledge piece extracted from input attack information piece based on an attack information piece similar to the input attack information piece by using the learning model.

A method for processing attack information according to the present disclosure includes: extracting first and second attack knowledge pieces indicating conditions of a cyber attack from first and second attack information pieces including descriptions of the cyber attack; determining similarity between the first and second attack information pieces; and complementing the first attack knowledge piece with the second attack knowledge piece based on the determined similarity.

A non-transitory computer readable medium storing an attack information processing program according to the present disclosure is a non-transitory computer readable medium storing an attack information processing program for causing a computer to execute processes of: extracting first and second attack knowledge pieces indicating conditions of a cyber attack from first and second attack information pieces including descriptions of the cyber attack; determining similarity between the first and second attack information pieces; and complementing the first attack knowledge piece with the second attack knowledge piece based on the determined similarity.

### Advantageous Effects of Invention

According to the present disclosure, it is possible to provide an attack information processing apparatus, an attack information processing method, and a non-transitory computer readable medium storing an attack information processing program, capable of obtaining more accurate attack knowledge.

### BRIEF DESCRIPTION OF DRAWINGS

FIG. 1 shows an example of attack information used in an example embodiment.

FIG. 2 shows a related method for generating attack knowledge.

FIG. 3 is a configuration diagram showing an outline of an attack information processing apparatus according to an example embodiment.

FIG. 4 shows an outline of a method for generating attack knowledge according to an example embodiment.

FIG. 5 is a configuration diagram showing a configuration example of an attack information processing system according to a first example embodiment.

FIG. 6 is a configuration diagram showing a configuration example of an information extraction unit according to the first example embodiment.

FIG. 7 is a configuration diagram showing a configuration example of a similarity determination unit according to the first example embodiment.

FIG. 8 is a flowchart showing an example of an operation performed by the attack information processing system according to the first example embodiment.

FIG. 9 is a flowchart showing an example of an information extraction process according to the first example embodiment.

FIG. 10 is a flowchart showing an example of a similarity determination process according to the first example embodiment.

FIG. 11 is a flowchart showing an example of an information complementing process according to the first example embodiment.

FIG. 12 shows a specific example of attack knowledge generation rules according to the first example embodiment.

FIG. 13 shows a specific example of similarity determination criteria according to the first example embodiment.

FIG. 14 shows a specific example of an information complementing process according to the first example embodiment.

FIG. 15 shows a specific example of an information complementing process according to the first example embodiment.

FIG. 16 is a configuration diagram showing a configuration example of an attack information processing system according to a second example embodiment.

FIG. 17 shows an example of an operation performed by the attack information processing system according to the second example embodiment.

FIG. 18 is a configuration diagram showing a configuration example of an attack information processing system according to a third example embodiment.

FIG. 19 shows an example of an operation performed by the attack information processing system according to the third example embodiment.

FIG. 20 is a configuration diagram showing a configuration example of an attack information processing system according to a fourth example embodiment.

FIG. 21 shows an example of an operation performed by the attack information processing system according to the fourth example embodiment.

FIG. 22 is a configuration diagram showing an outline of a hardware configuration of a computer according to an example embodiment.

### DESCRIPTION OF EMBODIMENTS

Example embodiments according to the present disclosure will be described hereinafter with reference to the drawings. The same symbols are assigned to the same elements throughout the drawings, and redundant explanations are omitted as necessary.

### Examination That has Lead to Example Embodiment

Firstly, attack information used in an example embodiment will be described. A typical example of the attack information is vulnerability information. The vulnerability information is, for example, CVE (Common Vulnerabilities and Exposures). The CVD are assigned CVE-IDs and are laid open to public on a CVE-ID-by-CVE-ID basis in a vulnerability information database on the Internet, such as the NVD.

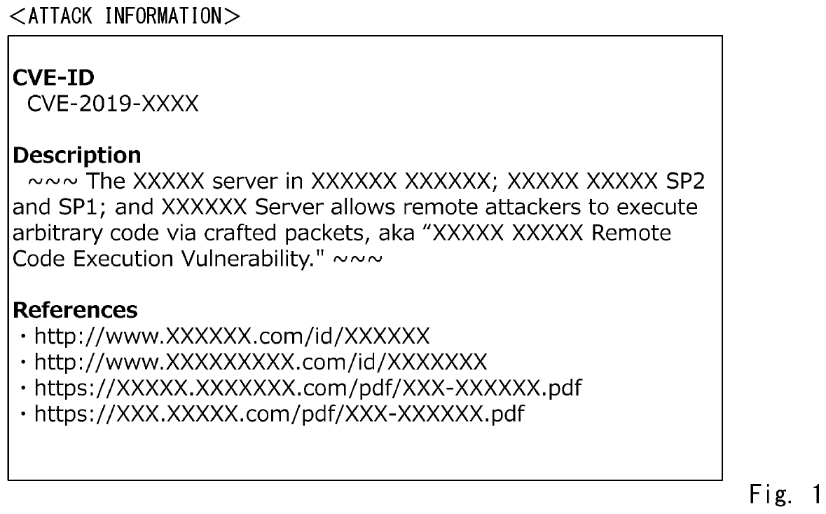

FIG. 1 shows a specific example of attack information (vulnerability information) that is laid open to the public in a vulnerability information database. As shown in FIG. 1, the attack information includes “CVE-IDs” assigned to respective attack information pieces, “Descriptions” in which the respective attack information pieces are described, “References” indicating reference information of the respective attack information pieces, and so on. As described above, the specific contents of the attack information are described in a natural language in the “Descriptions” and are not structuralized. Therefore, unless the attack information is processed, it cannot be introduced into a computer system and hence cannot be used for a security measure or the like.

Accordingly, the inventors have examined a method for generating attack knowledge that can be used in a computer system from attack information described in a natural language. The attack knowledge is information indicating conditions of an attack, and is information including preconditions of the attack, i.e., preliminary conditions of the attack and a result of the attack, i.e., post-attack conditions.

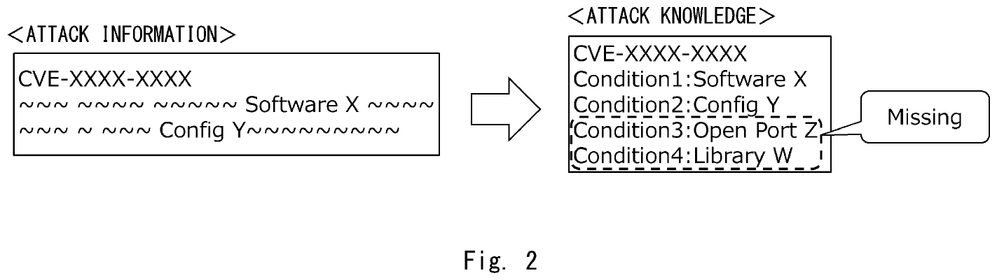

In the related art, attack knowledge is generated from attack information by using keyword matching and/or machine learning. However, as shown in FIG. 1, attack information (an information source) open to the public is often not described in a detailed manner. Therefore, the inventors have found a problem that it is impossible to obtain accurate attack knowledge by simply extracting the attack knowledge from attack information open to the public as shown in FIG. 2. For example, in the example shown in FIG. 2, since there are terms “Software” and “Config” in the attack information, correct conditions “Software” and “Config” can be obtained as attack knowledge pieces. However, since terms “Open Port” and “Library” are not in the attack information, their correct conditions cannot be obtained.

Therefore, example embodiments shown below make it possible to obtain more accurate attack knowledge even when attack information is not described in a detailed manner.

### Outline of Example Embodiment

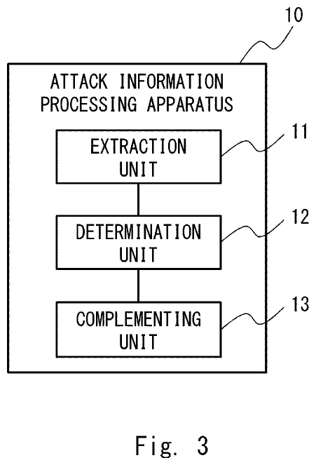

FIG. 3 shows an outline of an attack information processing apparatus 10 according to an example embodiment. As shown in FIG. 3, the attack information processing apparatus 10 includes an extraction unit 11, a determination unit 12, and a complementing unit 13.

The extraction unit 11 extracts first and second pieces of attack knowledge (hereinafter also referred to as first and second attack knowledge pieces (including items, attributes, etc.)) indicating conditions of a cyber attack from first and second pieces of attack information (hereinafter also referred to as first and second attack information pieces) including descriptions of the cyber attack. For example, the first attack information piece is an attack information piece to be analyzed (new attack information), and the second attack information piece is included in predetermined attack information (all known attack information to the extent possible). The determination unit 12 determines similarity between the first and second attack information pieces. The complementing unit 13 complements one of the first and second attack knowledge pieces with the other attack knowledge pieces based on the similarity determined by the determination unit 12.

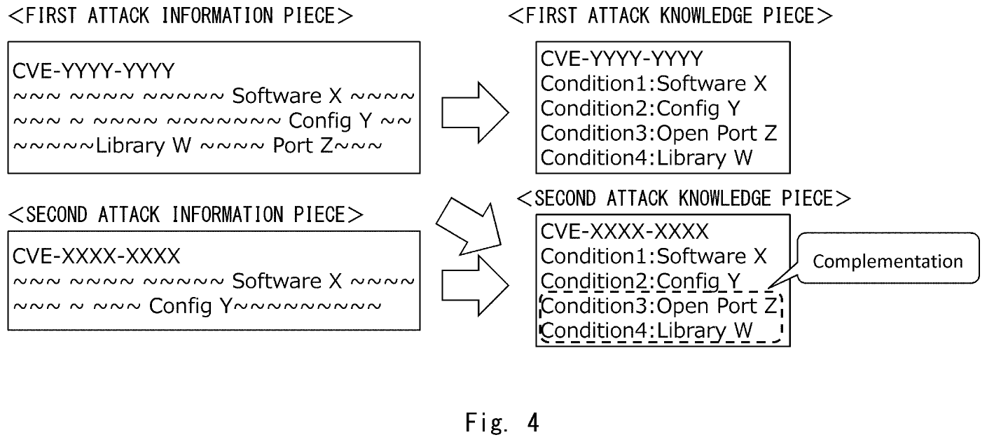

As described above, in the example embodiment, attack knowledge pieces are extracted from a plurality of attack information pieces, and the extracted attack knowledge pieces are complemented based on similarity between the plurality of attack information pieces. For example, as shown in FIG. 4, it is assumed that the first and second attack information pieces are similar to each other, and while the first attack information piece includes terms “Port” and “Library”, the second attack information piece does not include these terms “Port” and “Library”. In this case, the second attack knowledge piece is complemented by conditions “Open Port” and “Library” obtained in the first attack knowledge piece (obtained from the first attack information piece). In this way, it is possible to complement (i.e., fill up) missing information by combining a plurality of attack information pieces (information sources) and thereby to obtain more accurate attack knowledge.

### First Example Embodiment

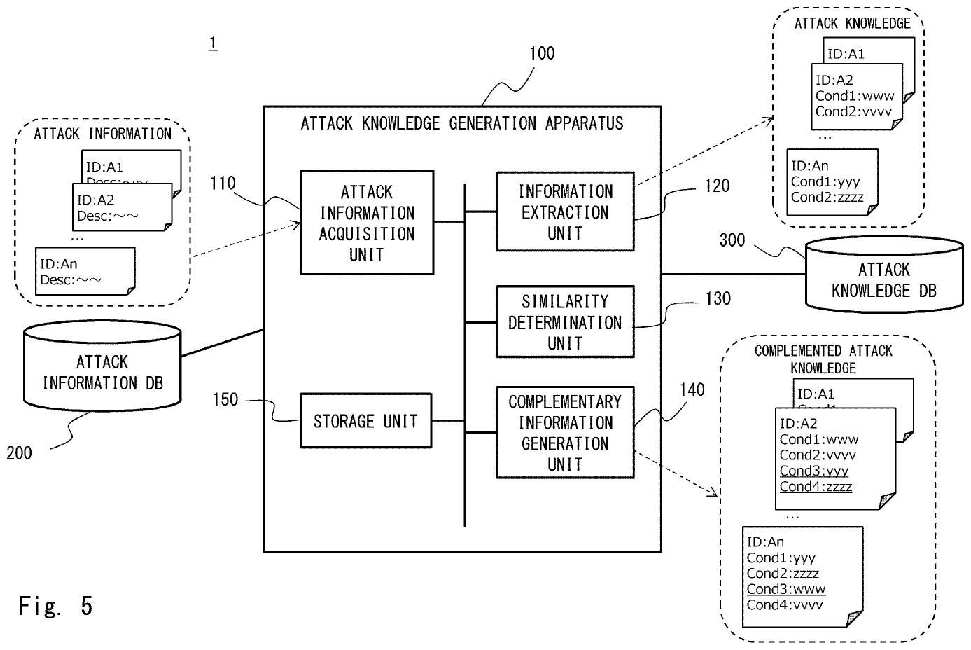

A first example embodiment will be described hereinafter with reference to the drawings. FIG. 5 shows a configuration example of an attack information processing system 1 according to this example embodiment. The attack information processing system 1 according to this example embodiment is a system that generates a plurality of attack knowledge pieces from a plurality of attack information pieces open to the public.

As shown in FIG. 5, the attack information processing system (or an attack information processing apparatus) 1 includes an attack knowledge generation apparatus 100, an attack information DB (database) 200, and an attack knowledge DB 300. The attack information DB 200 and the attack knowledge DB 300 may be connected to the attack knowledge generation apparatus 100 through a network such as the Internet, or may be directly connected to the attack knowledge generation apparatus 100. Alternatively, an apparatus including the attack knowledge generation apparatus 100, the attack information DB 200, and the attack knowledge DB 300 may be used.

The attack information DB 200 is a database that stores attack information open to the public, such as vulnerability information. The attack information DB 200 is a database that is laid open to the public by a public organization, such as CVE, NVD or JVN (Japan Vulnerability Notes), or a database that is laid open to the public by a security vendor or other vendors. Further, the attack information DB 200 is not limited to databases as long as it lays a plurality of attack information pieces open to the public, and may be, for example, a blog.

The attack information is attack-related information including a sentence written in a natural language. For example, the attack information is vulnerability information in which vulnerabilities of a computer system are described as shown in FIG. 1. The attack information is not limited to vulnerability information, but may be other types of information related to cyber attacks. For example, the attack information may be specifications or the like of a protocol that is not recognized as being vulnerable but is at risk of being attacked.

The attack knowledge DB 300 is a storage device that stores attack knowledge generated by the attack knowledge generation apparatus 100. The attack knowledge corresponds to the attack information stored in the attack information DB 200, and includes preconditions and a result of the attack (hereinafter also referred to as an attack result) as described above. For example, the preconditions are a used port, a used software library, etc. Further, the attack result is execution of code, a privilege escalation, access of a file, etc.

The attack knowledge generation apparatus 100 includes an attack information acquisition unit 110, an information extraction unit 120, a similarity determination unit 130, a complementary information generation unit 140, and a storage unit 150. Note that the attack knowledge generation apparatus 100 may have other configurations as long as it can perform operations described below.

The attack information acquisition unit 110 acquires a plurality of attack information pieces from the attack information DB 200. For example, the attack information acquisition unit 110 accesses a database such as NVD through the Internet and acquires attack information registered in the database.

The information extraction unit 120 generates attack knowledge based on the attack information acquired by the attack information acquisition unit 110. The information extraction unit 120 extracts, from the attack information, information including a sentence written in a natural language, and thereby generates attack knowledge in a predetermined format. The information extraction unit 120 stores the generated attack knowledge in the attack knowledge DB 300.

The similarity determination unit 130 determines similarity between a plurality of attack information pieces. The similarity determination unit 130 may determine similarity by using attack information acquired by the attack information acquisition unit 110, or may determine similarity by using information extracted by the information extraction unit 120. The similarity determination unit 130 may determine similarity based on one determination criterion, or may determine similarity by combining a plurality of determination criteria.

The complementary information generation unit 140 complements attack knowledge based on attack knowledge of similar attack information. When it is determined that a plurality of attack information pieces are similar to each other, the complementary information generation unit 140 complements each of attack knowledge pieces thereof by using information of the attack knowledge piece of the similar attack information (i.e., by using the attack knowledge piece of the other attack information). The complementary information generation unit 140 complements and updates attack knowledge stored in the attack knowledge DB 300 in accordance with the similarity (the degree of similarity).

The storage unit 150 stores information necessary for operations (processes) performed by the attack knowledge generation apparatus 100. For example, the storage unit 150 may be a nonvolatile memory such as a flash memory or a hard disk drive. For example, the storage unit 150 stores acquired attack information, a learning model necessary for an information extraction process, and so on. Note that, if necessary, the learning model or the like may be externally acquired.

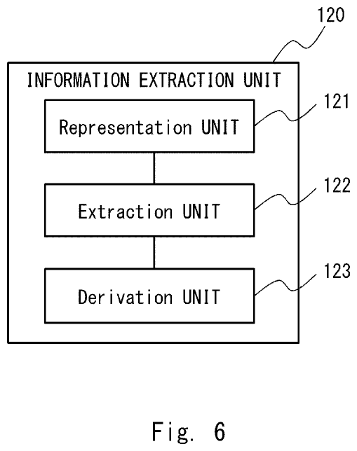

FIG. 6 shows a configuration example of the information extraction unit 120. As shown in FIG. 6, for example, the information extraction unit 120 includes a Representation unit 121, an Extraction unit 122, and a Derivation unit 123. The Representation unit 121 is a distributed representation vector generation unit that acquires a distributed representation vector of each word included in input attack information. The Extraction unit 122 is a labeling unit that labels each of the words in the attack information, which have been converted into a series of distributed representation vectors. The Derivation unit 123 is an attack knowledge generation unit that generates attack knowledge in accordance with predetermined rules based on the assigned labels.

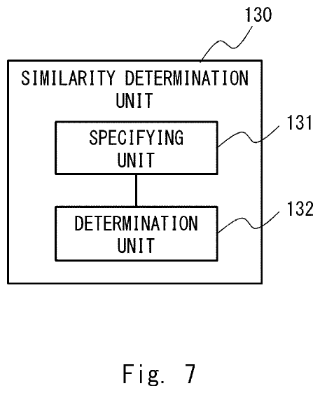

FIG. 7 shows a configuration example of the similarity determination unit 130. As shown in FIG. 7, for example, the similarity determination unit 130 includes a specifying unit 131 and a determination unit 132. The specifying unit 131 specifies a determination criterion for determining similarity. The determination unit 132 determines similarity (a degree of similarity) between a plurality of attack information pieces in accordance with the specified determination criterion.

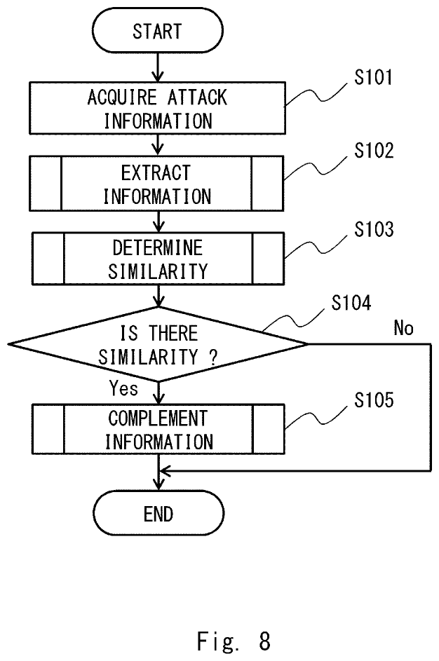

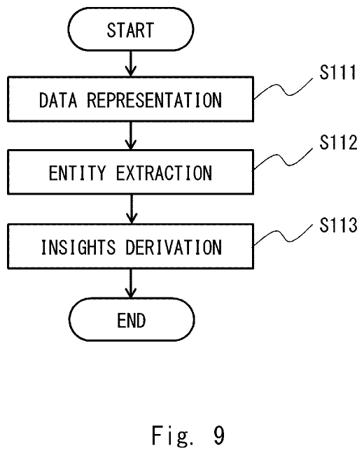

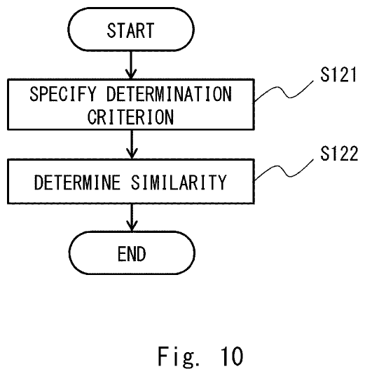

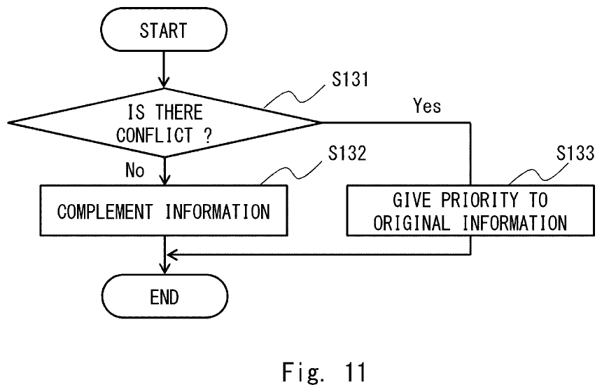

Next, operations performed by the attack information processing system 1 according to this example embodiment will be described. FIG. 8 shows a flow from an acquisition of attack information to generation of complemented attack knowledge in the attack information processing system 1 according to this example embodiment. FIG. 9 shows a flow of an information extraction process (S102) shown in FIG. 8, and FIG. 10 shows a flow of similarity determination process (S103) shown in FIG. 8. Further, FIG. 11 shows a flow of an information complementing process (S105) shown in FIG. 8.

As shown in FIG. 8, firstly, the attack knowledge generation apparatus 100 acquires attack information (S101) and extracts information from the acquired attack information (S102). When the attack information acquisition unit 110 acquires a plurality of attack information pieces from the attack information DB 200, the information extraction unit 120 extracts information from the plurality of acquired attack information pieces and thereby generates a plurality of attack knowledge pieces from the extracted information.

In the information extraction process (S102), the Representation unit 121 performs a Data Representation process (S111) as shown in FIG. 9. The Representation unit 121 divides a sentence included in the acquired attack information into words (morphemes) and acquires a distributed representation vector of each of the obtained words. The distributed representation vector can be acquired by using a distributed representation tool such as Word2Vec (skip-gram, CBoW (Continuous Bag-of-Words)). Note that the unit (e.g., the morpheme) from which one distributed representation vector is acquired may be one word or may be composed of a plurality of words. For example, a commonly-used phrase composed of a plurality of words, such as “Denial of service”, may be regarded as one word and hence one distributed representation vector may be acquired from such a phrase. For example, the Representation unit 121 generates a learning model that has learned distributed representations in a plurality of attack information pieces in advance and stores the generated learning model in the storage unit 150. Then, the Representation unit 121 acquires distributed representation vectors in input attack information by using the stored distributed-representation learning model.

Next, the Extraction unit 122 performs an Entity Extraction process (S112). The Extraction unit 122 assigns a label related to the attack knowledge to each of the words in the attack information, for which distributed representation vectors have been acquired. The label corresponds to a condition of the attack knowledge. For example, the label corresponds to software, a version, an OS, a protocol, a port, attacking means, an attack result, an attack vector, authentication, permission, a security mechanism, or the like. Note that a plurality of labels may be assigned to one word. For example, the Extraction unit 122 generates a learning model that has learned teacher data indicating labels of words in advance, and stores the learning model in the storage unit 150. Then, the Extraction unit 122 assigns labels to the words, for which distributed representation vectors have been acquired, by using the stored label learning model.

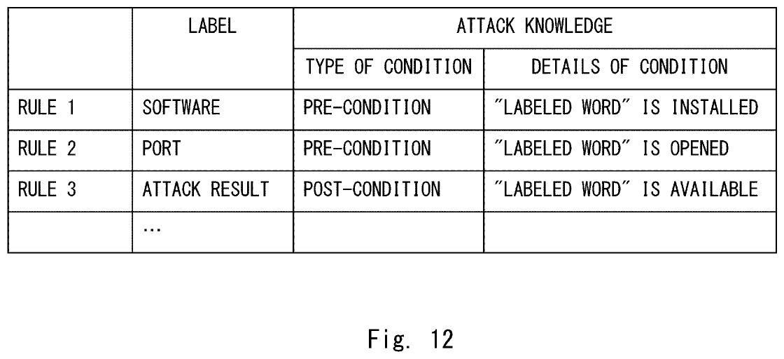

Next, the Derivation unit 123 performs an Insights Derivation process (S113). The Derivation unit 123 generates attack knowledge in accordance with rules, which associate the labels with the conditions of the attack knowledge pieces, based on the assigned label. FIG. 12 shows an example of rules for generating attack knowledge pieces from labels. Conversion rules like those shown in FIG. 12 are stored in the storage unit 150 in advance and attack knowledge pieces are generated by using the stored conversion rules. As shown in FIG. 12, for example, in the conversion rules, each label is associated with a type of condition of an attack knowledge piece and details of condition thereof. The condition type indicates a precondition or an attack result (i.e., a post-condition).

A Rule 1 is an example of a rule when a label of a word is “software”. According to the Rule 1, for example, when a word “browser A” has a label “software” assigned thereto, the Derivation unit 123 incorporates a condition {pre-condition, “Browser A” is installed} into the attack knowledge.

A Rule 2 is an example of a rule when a label of a word is “port”. According to the Rule 2, for example, when a word “port 120” has a label “port” assigned thereto, the Derivation unit 123 incorporates a condition {pre-condition, “Port 120” is opened} into the attack knowledge.

A Rule 3 is an example of a rule when a label of a word is “attack result”. According to the Rule 3, for example, when a word “execution of code” has a label “result of attack” assigned thereto, the Derivation unit 123 incorporates a condition {post-condition, “execution of code” becomes possible} in the attack knowledge.

Next, the attack knowledge generation apparatus 100 determines similarity of attack information (S103). As described above, when the information extraction unit 120 generates attack knowledge based on attack information, the similarity determination unit 130 determines similarity of the attack information in order to determine whether or not the attack information can be complemented. Note that since the similarity may be determined based on the attack information or may be determined based on information obtained by the information extraction process, the similarity determination process may be performed after the information extraction process or may be performed simultaneously with the information extraction process.

In the similarity determination process (S103), as shown in FIG. 10, the specifying unit 131 specifies a determination criterion for determining similarity (S121), and the determination unit 132 determines similarity between a plurality of attack information pieces in accordance with the specified determination criterion. Note that in the similarity determination process, the determination unit 132 may determine whether or not a plurality of attack information pieces are similar to each other, or may determine a degree of similarity between a plurality of attack information pieces.

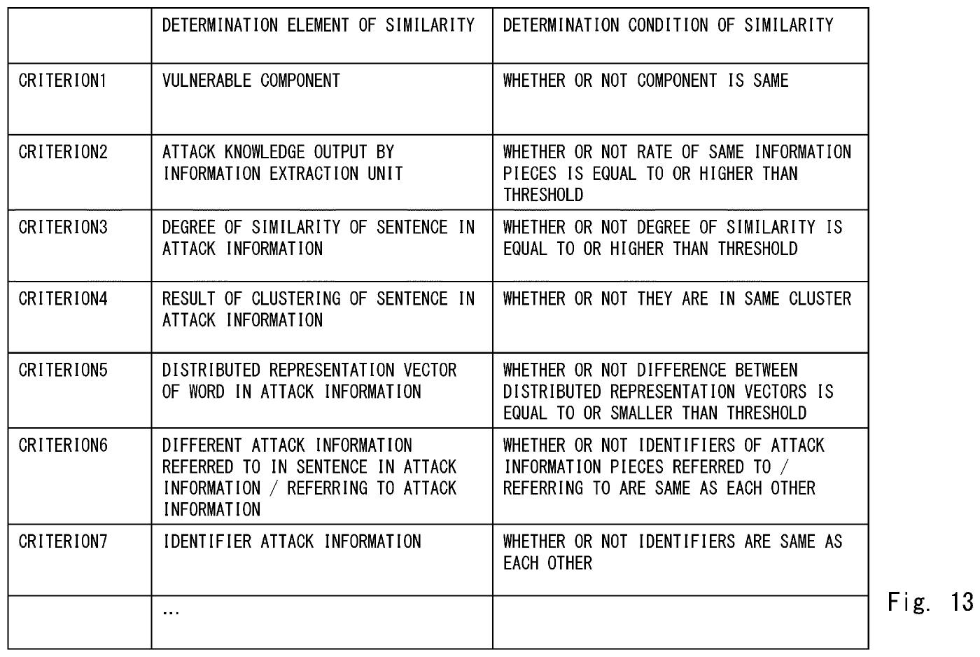

FIG. 13 shows an example of determination criteria for determining similarity between a plurality of attack information pieces. Determination criteria like those shown in FIG. 13 are stored in the storage unit 150 in advance and similarity is determined by using the stored determination criteria. For example, the specifying unit 131 selects at least one of the determination criteria including determination elements and determination conditions as shown in FIG. 13. Further, the determination unit 132 determines similarity in accordance with the selected determination criterion. A plurality of determination criteria may be combined by using an AND condition for the determination process, or may be combined by using an OR condition for the determination process.

A Criterion 1 is an example of a determination criterion in which a target component of attack information is used as an element for determining similarity. Information of the component may be directly acquired from information included in the attack information, or may be acquired from information extracted by the information extraction unit 120 (i.e., from labeled words or generated attack knowledge). For example, the components may be software, middleware, hardware, or the like. Note that the component is an example of the unit of the determination element. That is, the unit of the determination element is not limited to components and may be a module, a library, or the like. According to the Criterion 1, for example, when vulnerable components obtained from a plurality of attack information pieces are the same as each other, the determination unit 132 determines that the plurality of attack information pieces are similar to each other. Note that the components do not necessarily have to be the same as each other. That is, when the components are related to each other, the determination unit 132 may determine that the attack information pieces are similar to each other.

A Criterion 2 is an example of a determination criterion in which attack knowledge output from the information extraction unit 120 is used as an element for determining similarity. The determination unit 132 determines whether preconditions and attack results included in one of attack knowledge pieces are the same as those included in other attack knowledge piece. According to the Criterion 2, for example, when a rate of the number of the same preconditions and the same attack results to the number of all the preconditions and all the attack results included in a plurality of attack knowledge pieces generated by the information extraction unit 120 is equal to or higher than a predetermined threshold, the determination unit 132 determines that the plurality of attack information pieces are similar to each other.

A Criterion 3 is an example of a determination criterion in which a degree of similarity between sentences included in attack information pieces is used as a determination element. That is, similarity is determined based on the description in the “Description” of the attack information. For example, a feature value such as a frequency of appearances or an order of appearances of a specific word included in a sentence in the attack information, statistical information thereof, or the like is used as a degree of similarity. Then, similarity is determined based on a result of a comparison between the degree of similarity and a predetermined threshold. According to the Criterion 3, for example, the determination unit 132 calculates feature values of sentences written in the “Description” of a plurality of attack information pieces. Then, when a calculated degree of similarity is equal to or greater than a predetermined threshold, the determination unit 132 determines that the plurality of attack information pieces are similar to each other.

A Criterion 4 is an example of a determination criterion in which a result of clustering of sentences in attack information is used as a determination element. For example, similarly to the Criterion 3, a frequency of appearances or an order of appearances of a specific word included in a sentence in the attack information, statistical information thereof, or the like is used as a feature value. Then, clustering is performed based on the feature value. A result of this clustering is used as a degree of similarity. According to the Criterion 4, for example, the determination unit 132 calculates feature values of sentences written in the “Description” of a plurality of attack information pieces and performs clustering based on the calculated feature values. Then, when a plurality of attack information pieces are classified into the same cluster, the determination unit 132 determines that the plurality of attack information pieces are similar to each other.

A Criterion 5 is an example of a determination criterion in which a distributed representation vector of a word in attack information extracted by the information extraction unit 120 is used as a determination element. It is considered that when distributed representation vectors of words are close (or similar) to each other, the words are similar to each other. Therefore, similarity is determined based on a difference between the distributed representation vectors. According to the Criterion 5, for example, the determination unit 132 determines, for each of elements (words) in sentences in a plurality of attack information pieces labeled by the information extraction unit 120, a difference of a distributed representation vector of that element. An average value or a weighted average value of differences of distributed representation vectors of these elements is used as a degree of similarity. Then, when this degree of similarity is equal to or lower than a predetermined threshold, the determination unit 132 determines that the plurality of attack information pieces are similar to each other.

A Criterion 6 is an example of a determination criterion in which another attack information piece that is referred to in a sentence in the attack information piece of interest or refers to the attack information piece of interest is used as a determination element. That is, similarity is determined based on reference information included in the attack information. For example, similarity is determined based on an identifier of attack information extracted from a sentence of the attack information. For example, if the attack information is CVE, its identifier is a CVE-ID. According to the Criterion 6, for example, the determination unit 132 acquires identifiers referred to in the “Description” of a plurality of attack information pieces. Then, when the acquired identifiers are the same as each other, the determination unit 132 determines that the plurality of attack information pieces are similar to each other. Note that the information referred to in the attack information is not limited to those referred to in the “Description” of the attack information, but may be information referred to in the “References” of the attack information. Further, when the attack information includes CVE-compatible information, vulnerability classification information, or the like, they may be referred to.

A Criterion 7 is an example of a determination criterion in which an identifier of the attack information is used as a determination element. That is, similarity is determined based on identification information of attack information included in the attack information. There are cases where different information sources disclose the same attack information. Therefore, similarity is determined based on the identifier of the attack information. Similarly to the Criterion 6, for example, when the attack information is CVE, the identifier is a CVE-ID. According to the Criterion 7, for example, the determination unit 132 acquires CVE-IDs described in the “CVE-ID” of a plurality of attack information pieces. Then, when the CVE-IDs are the same as each other, the determination unit 132 determines that the plurality of attack information pieces are similar to each other.

Next, the attack knowledge generation apparatus 100 determines whether or not there is similarity (S104). Then, when there is similarity between the plurality of attack information pieces, the attack knowledge generation apparatus 100 complements information of the attack knowledge (S105). As described above, when the similarity determination unit 130 determines that a plurality of attack information pieces are similar to each other, the complementary information generation unit 140 complements the precondition and the attack result of the attack information pieces by using information included therein.

Note that information may be complemented when there is similarity as a result of a determination as to the presence/absence of similarity, or may be complemented according to the degree of similarity. For example, information may be complemented by using only an attack information piece(s) having a degree of similarity higher than a predetermined threshold. The number of conditions in attack knowledge can be increased by lowering the threshold. Conversely, conditions in attack knowledge can be narrowed down by raising the threshold. This threshold may be defined according to the property (or assets) to be protected and/or the risk thereof.

In the information complementing process (S105), as shown in FIG. 11, the complementary information generation unit 140 determines whether or not there is a Conflict between information pieces to be complemented (S131). When a condition originally included in attack knowledge to be complemented and a condition to be added in that attack knowledge cannot coexist with each other as conditions of the attack, it is determined that there is a conflict. That is, when an AND condition cannot hold due to the presence of both of the conditions, there is a conflict. For example, a condition that the component is an operating system A and a condition that the component is an operating system B do not simultaneously hold, so that it is determined that there is a conflict.

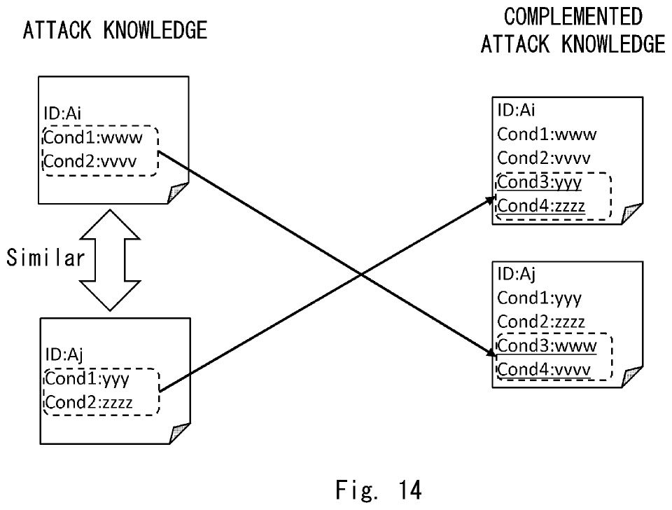

When there is no conflict in the information to be complemented, the complementary information generation unit 140 complements the information in the plurality of attack knowledge pieces with each other (S132). For example, as shown in FIG. 14, when it is determined that attack information pieces Ai and Aj are similar to each other, the complementary information generation unit 140 complements an attack knowledge piece Aj by using part of the information included in the attack information piece Ai and complements an attack knowledge piece Ai by using part of the information included in the attack information piece Aj.

In this example, the attack knowledge of the attack information piece Ai includes “www” and “vvv” as preconditions or attack results, and the attack knowledge of the attack information piece Aj includes “yyy” and “zzz” as preconditions or attack results. Then, “yyy” and “zzz” included in the attack knowledge of the attack information piece Aj are added to the attack knowledge included in the attack information piece Ai, and “www” and “vvv” included in the attack knowledge of the attack information piece Ai are added to the attack knowledge included in the attack information piece Aj.

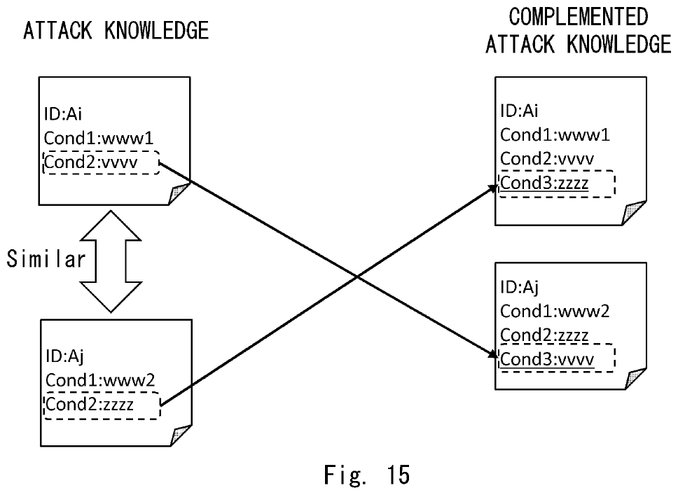

On the other hand, when there is a conflict in the information to be complemented, the complementary information generation unit 140 complements the information while giving a priority to the information originally included in the attack knowledge to be complemented (S133). For example, as shown in FIG. 15, when it is determined that attack information pieces Ai and Aj are similar to each other and parts of the attack information pieces Ai and Aj conflict with each other, the complementary information generation unit 140 does not add the conflicting information. That is, the complementary information generation unit 140 complements the attack information by using information other than the conflicting information.

In this example, the attack knowledge of the attack information piece Ai includes “www1” and “vvv” as preconditions or attack results, and the attack knowledge of the attack information piece Aj includes “www2” and “zzz” as preconditions or attack results. In this case, it is assumed that there is a conflict between “www1” and “www2”. Then, among the conditions included in the attack knowledge of the attack information piece Aj, “www2”, which would cause the conflict, is not added in the attack knowledge of the attack information piece Ai. That is, only “zzz”, which causes no conflict, is added in the attack knowledge of the attack information piece Ai. Further, among the conditions included in the attack knowledge of the attack information piece Ai, “www1”, which would cause the conflict, is not added in the attack knowledge of the attack information piece Aj. That is, only “vvv”, which causes no conflict, is added in the attack knowledge of the attack information piece Aj.

As described above, in this example embodiment, attack knowledge including preconditions and attack results is generated from attack information open to the public, such as vulnerability information, and the generated attack knowledge is complemented by using similar attack information. In this way, even when attack information is not described in a detailed manner, attack knowledge can be complemented by using conditions included in other attack information, and thus making it possible to generate more accurate attack knowledge.

### Second Example Embodiment

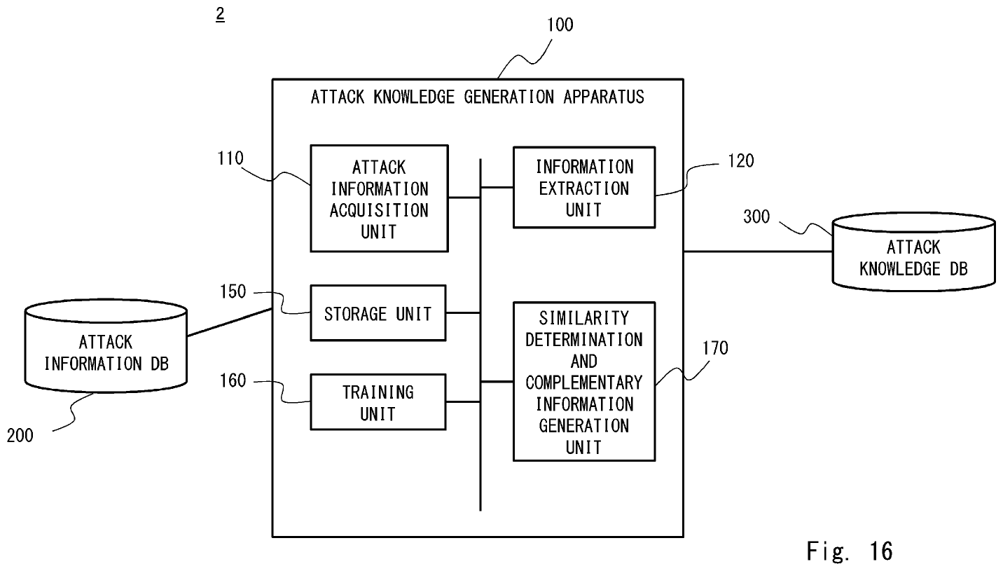

Next, a second example embodiment will be described with reference to the drawings. FIG. 16 shows a configuration example of an attack information processing system 2 according to this example embodiment. As shown in FIG. 16, the attack information processing system 2 includes an attack knowledge generation apparatus 100, an attack information DB 200, and an attack knowledge DB 300, as in the case of the first example embodiment.

As compared to the configuration of the first example embodiment, the attack knowledge generation apparatus 100 further includes a training unit 160, and includes a similarity determination and complementary information generation unit 170 in place of the similarity determination unit 130 and the complementary information generation unit 140.

The training unit 160 is a learning unit that learns (trains) attack information and attack knowledge generated by the information extraction unit 120. The similarity determination and complementary information generation unit 170 realizes the same functions as those of the similarity determination unit 130 and the complementary information generation unit 140 by using a learning model trained by the training unit 160.

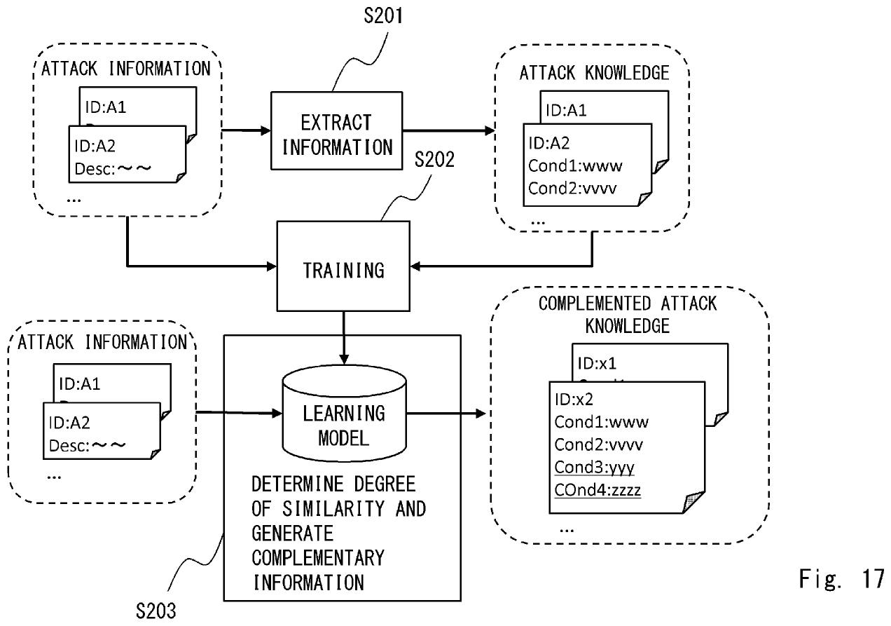

FIG. 17 shows a flow of operations performed by the attack information processing system 2 according to this example embodiment. As shown in FIG. 17, similarly to the first example embodiment, the information extraction unit 120 generates attack knowledge from attack information (S201). Next, the training unit 160 learns the attack information and the attack knowledge generated by the information extraction unit 120, and thereby generates a learning model (S202). Next, the similarity determination and complementary information generation unit 170 determines a degree of similarity and generates complementary information by using the learning model trained by the training unit 160 (S203). The similarity determination and complementary information generation unit 170 extracts attack knowledge from the attack information that is input by using the learning model, and complements the extracted attack knowledge based on attack information similar to the input attack information. A method for determining similarity and a method for complementing information are the same as those in the first example embodiment.

In this example embodiment, the learning model is trained so as to directly output attack information and attack knowledge complemented by using the output from the information extraction unit. For example, a separate learning model is generated for each attack knowledge piece to be generated (such as for each attack condition or the like). In this way, it is possible to determine a degree of similarity and generate complementary information at the same time.

### Third Example Embodiment

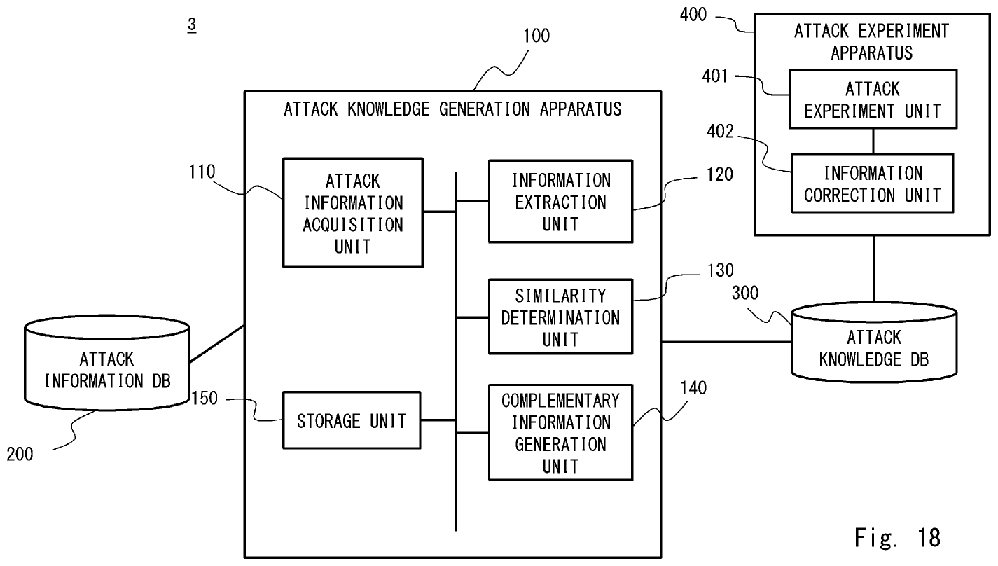

Next, a third example embodiment will be described with reference to the drawings. FIG. 18 shows a configuration example of an attack information processing system 3 according to this example embodiment. As shown in FIG. 18, the attack information processing system 3 includes an attack knowledge generation apparatus 100, an attack information DB 200, and an attack knowledge DB 300 as in the case of the first and second example embodiments, and further includes an attack experiment apparatus 400.

The attack experiment apparatus 400 includes an attack experiment unit 401 and an information correction unit 402. The attack experiment unit 401 performs an attack experiment by using attack knowledge generated by the attack knowledge generation apparatus 100. The information correction unit 402 corrects the attack knowledge based on a result of an attack made by the attack experiment unit 401.

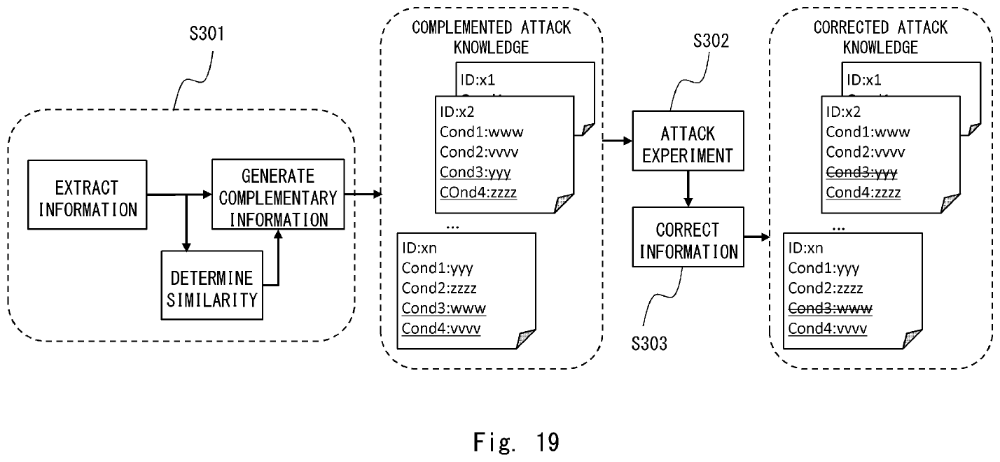

FIG. 19 shows a flow of operations performed by the attack information processing system 3 according to this example embodiment. As shown in FIG. 19, similarly to the first and second example embodiments, the attack knowledge generation apparatus 100 extracts attack knowledge from attack information, determines similarity of the attack information, and complements the attack knowledge based on the similarity of the attack information (S301).

Next, the attack experiment unit 401 performs an attack experiment by using the attack knowledge generated by the attack knowledge generation apparatus 100 (S302). The attack experiment unit 401 constructs an attack environment based on conditions included in the complemented attack knowledge. Further, the attack experiment unit 401 observes whether or not an attack can be actually made in the attack environment from the conditions included in the attack knowledge and also observes a result of the attack.

Next, the information correction unit 402 corrects the attack knowledge based on the result of the attack made by the attack experiment unit 401 (S303). The information correction unit 402 corrects the attack knowledge based on the observed information. For example, when the attack experiment ends in failure, some of the conditions included in the attack knowledge are corrected and an attack experiment is further carried out by using the corrected attack knowledge. These processes are repeated until the attack experiment succeeds.

In this example embodiment, in addition to the configuration of the first and second example embodiments, an attack experiment is carried out by using complemented attack knowledge. By doing so, it is possible to improve the accuracy of the generation of attack knowledge even further.

### Fourth Example Embodiment

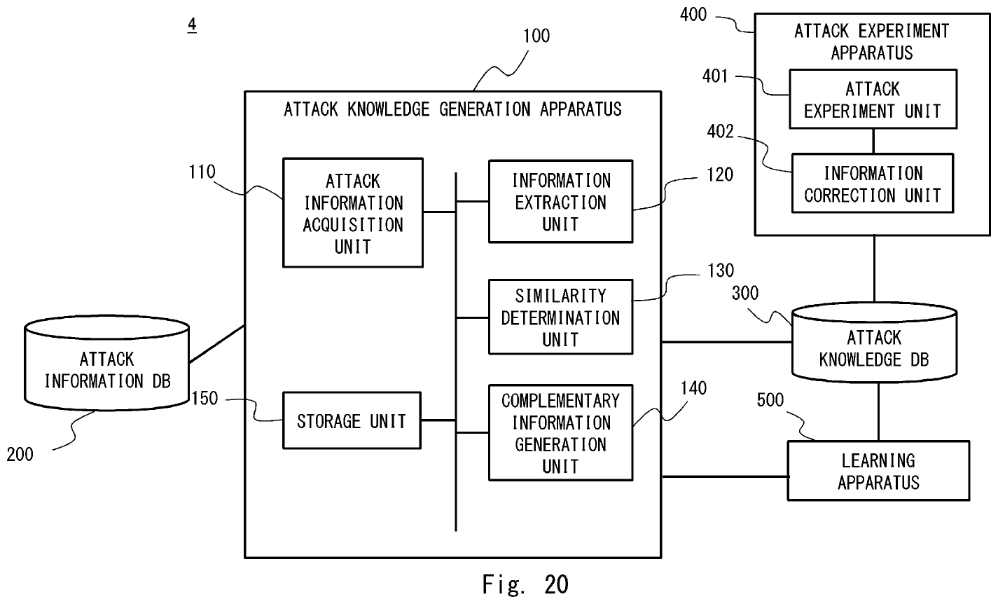

Next, a fourth example embodiment will be described with reference to the drawings. FIG. 20 shows a configuration example of an attack information processing system 4 according to this example embodiment. As shown in FIG. 20, the attack information processing system 4 includes an attack knowledge generation apparatus 100, an attack information DB 200, an attack knowledge DB 300, and an attack experiment apparatus 400 as in the case of the third example embodiment, and further includes a learning apparatus 500. The learning apparatus 500 learns attack knowledge corrected by the attack experiment apparatus 400. The learning model is used in the information extraction process performed by the information extraction unit 120, the similarity determination process performed by the similarity determination unit 130, and the information complementing process performed by the complementary information generation unit 140.

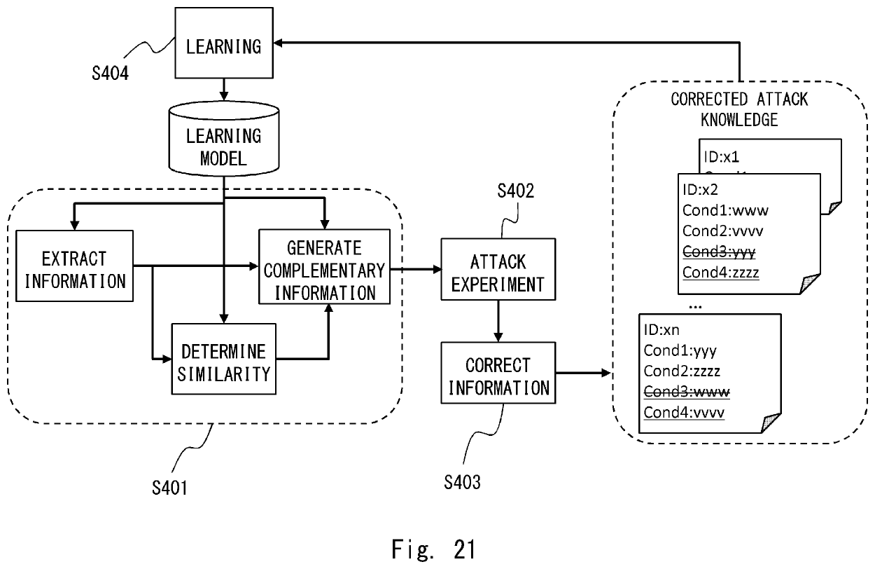

FIG. 21 shows a flow of operations performed by the attack information processing system 4 according to this example embodiment. As shown in FIG. 21, similarly to the first and second example embodiments, the attack knowledge generation apparatus 100 extracts attack knowledge from attack information, determines similarity of the attack information, and complements the attack knowledge based on the similarity of the attack information (S401). Next, similarly to the third example embodiment, the attack experiment apparatus 400 performs an attack experiment (S402) and corrects the attack knowledge based on a result of the attack experiment (S403).

Next, the learning apparatus 500 learns the attack knowledge corrected by the attack experiment apparatus 400 and thereby generates a learning model (S404). After that, by using the generated learning model, the attack knowledge generation apparatus 100 extracts information, determines similarity, and generates complementary information. The learning model is used in some or all of the information extraction process, the similarity determination process, and the complementary information generation process.

In this example embodiment, it is possible to further improve the accuracy of the generation of attack knowledge by feeding back the result of the attack experiment to the information extraction unit and/or the similarity determination unit.

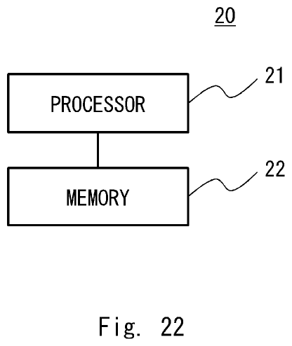

Note that each configuration in the above-described example embodiments may be constructed by software, hardware, or both of them. Further, each configuration may be constructed by one hardware device or one software program, or a plurality of hardware devices or a plurality of software programs. As shown in FIG. 22, each apparatus and each function (each process) may be implemented by a computer 20 including a processor 21 such as a CPU (Central Processing Unit) and a memory 22, i.e., a storage device. For example, a program (an attack information processing program) for performing a method according to an example embodiment may be stored in the memory 22, and each function may be implemented by having the processor 21 execute a program stored in the memory 22.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Note that the present disclosure is not limited to the above-described example embodiments and can be modified as appropriate without departing from the scope and spirit of the disclosure.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

The whole or part of the example embodiments disclosed above can be described as, but not limited to, the following supplementary notes.

### (Supplementary Note 1)

An attack information processing apparatus comprising:

an extraction unit configured to extract first and second attack knowledge pieces indicating conditions of a cyber attack from first and second attack information pieces including descriptions of the cyber attack;

a determination unit configured to determine similarity between the first and second attack information pieces; and

a complementing unit configured to complement the first attack knowledge piece with the second attack knowledge piece based on the determined similarity.

### (Supplementary Note 2)

The attack information processing apparatus described in Supplementary note 1, wherein each of the first and second attack information pieces is vulnerability information in which a vulnerability of a computer system is described.

### (Supplementary Note 3)

The attack information processing apparatus described in Supplementary note 1 or 2, wherein each of the first and second attack knowledge pieces includes a precondition and a result of a cyber attack.

### (Supplementary Note 4)

The attack information processing apparatus described in any one of Supplementary notes 1 to 3, wherein the extraction unit acquires distributed representation vectors of morphemes obtained by dividing sentences in the first and second attack information pieces and extracts the first and second attack knowledge pieces based on the acquired distributed representation vectors.

### (Supplementary Note 5)

The attack information processing apparatus described in Supplementary note 4, wherein the morpheme is one word or is composed of a plurality of words.

### (Supplementary Note 6)

The attack information processing apparatus described in Supplementary note 4 or 5, wherein the extraction unit assigns labels related to the first and second attack knowledge pieces to the morphemes of which the distributed representation vectors have been acquired, and extracts the first and second attack knowledge pieces based on the assigned labels.

### (Supplementary Note 7)

The attack information processing apparatus described in Supplementary note 6, wherein the extraction unit extracts the first and second attack knowledge pieces based on a correspondence relation between the labels and conditions in the attack knowledge pieces.

### (Supplementary Note 8)

The attack information processing apparatus described in Supplementary note 6 or 7, wherein the determination unit determines the similarity based on a difference of the distributed representation vector of each of the morphemes to which the labels have been assigned.

### (Supplementary Note 9)

The attack information processing apparatus described in Supplementary note 8, wherein the determination unit determines the similarity based on an average value or a weighted average value of the differences of the distributed representation vectors.

### (Supplementary Note 10)

The attack information processing apparatus described in any one of Supplementary notes 1 to 9, wherein the determination unit determines the similarity based on information of components included in the first and second attack information pieces.

### (Supplementary Note 11)

The attack information processing apparatus described in any one of Supplementary notes 1 to 10, wherein the determination unit determines the similarity based on descriptions in Descriptions of the first and second attack information pieces.

### (Supplementary Note 12)

The attack information processing apparatus described in any one of Supplementary notes 1 to 11, wherein the determination unit determines the similarity based on reference information in the first and second attack information pieces.

### (Supplementary Note 13)

The attack information processing apparatus described in any one of Supplementary notes 1 to 12, wherein the determination unit determines the similarity based on identification information of the first and second attack information pieces.

### (Supplementary Note 14)

The attack information processing apparatus described in any one of Supplementary notes 1 to 13, wherein the determination unit determines the similarity based on a degree of similarity between sentences in the first and second attack information pieces.

### (Supplementary Note 15)

The attack information processing apparatus described in Supplementary note 14, wherein the degree of similarity is a degree of similarity based on a feature value including a frequency of appearances of a specific word, an order of appearances of a specific word, or statistical information thereof in the first and second attack information pieces.

### (Supplementary Note 16)

The attack information processing apparatus described in Supplementary note 15, wherein the degree of similarity is a degree of similarity of a result of clustering of the feature value.

### (Supplementary Note 17)

The attack information processing apparatus described in any one of Supplementary notes 14 to 16, wherein the determination unit determines the similarity based on a result of a comparison between the degree of similarity and a predetermined value.

### (Supplementary Note 18)

The attack information processing apparatus described in any one of Supplementary notes 1 to 17, wherein the determination unit determines the similarity based on the extracted attack knowledge pieces.

### (Supplementary Note 19)

The attack information processing apparatus described in Supplementary note 18, wherein the determination unit determines the similarity based on a rate at which conditions included in the first and second attack knowledge pieces match each other.

### (Supplementary Note 20)

The attack information processing apparatus described in any one of Supplementary notes 1 to 19, wherein when it is determined that the first and second attack information pieces are similar to each other, the complementing unit complements the first attack knowledge piece.

### (Supplementary Note 21)

The attack information processing apparatus described in any one of Supplementary notes 1 to 19, wherein the complementing unit complements the first attack knowledge piece according to a degree of similarity between the first and second attack information pieces.

### (Supplementary Note 22)

The attack information processing apparatus described in any one of Supplementary notes 1 to 21, wherein when a condition included in the first attack knowledge piece conflicts with a condition included in the second attack knowledge piece, the complementing unit complements the first attack knowledge piece while giving a priority to a condition originally included in the first attack knowledge piece to be complemented.

### (Supplementary Note 23)

The attack information processing apparatus described in any one of Supplementary notes 1 to 22, wherein the first attack information piece is an attack information piece to be analyzed, and the second attack information piece is included in predetermined attack information.

### (Supplementary Note 24)

An attack information processing apparatus comprising:

An extraction unit configured to extract a plurality of attack knowledge pieces indicating conditions of a cyber attack from a plurality of attack information pieces including descriptions of the cyber attack;

learning unit configured to generate a learning model that has learned a relation between the plurality of attack information pieces and the plurality of attack knowledge pieces; and

complementing unit configured to complement an attack knowledge piece extracted from input attack information piece based on an attack information piece similar to the input attack information piece by using the learning model.

### (Supplementary Note 25)

The attack information processing apparatus described in any one of Supplementary notes 1 to 23, further comprising:

an attack experiment unit configured to construct an experiment environment based on a condition included in the complemented attack knowledge piece and carry out an experiment of the cyber attack in the experiment environment; and

a correction unit configured to correct the attack knowledge piece complemented based on a result of the experiment.

### (Supplementary Note 26)

The attack information processing apparatus described in Supplementary note 25, further comprising a learning unit configured to generate a learning model that is used based on the result of the experiment by the extraction unit, the determination unit, or the complementing unit.

(Supplementary note 27)

A method for processing attack information comprising:

extracting first and second attack knowledge pieces indicating conditions of a cyber attack from first and second attack information pieces including descriptions of the cyber attack;

determining similarity between the first and second attack information pieces; and

complementing the first attack knowledge piece with the second attack knowledge piece based on the determined similarity.

### (Supplementary Note 28)

The method for processing attack information described in Supplementary note 27, wherein each of the first and second attack information pieces is vulnerability information in which a vulnerability of a computer system is described.

### (Supplementary Note 29)

An attack information processing program for causing a computer to execute processes of:

extracting first and second attack knowledge pieces indicating conditions of a cyber attack from first and second attack information pieces including descriptions of the cyber attack;

determining similarity between the first and second attack information pieces; and

complementing the first attack knowledge piece with the second attack knowledge piece based on the determined similarity.

### (Supplementary Note 30)

The attack information processing program described in Supplementary note 29, wherein each of the first and second attack information pieces is vulnerability information in which a vulnerability of a computer system is described.

### REFERENCE SIGNS LIST

1 to 4 ATTACK INFORMATION PROCESSING SYSTEM
10 ATTACK INFORMATION PROCESSING APPARATUS
11 EXTRACTION UNIT
12 DETERMINATION UNIT
13 COMPLEMENTING UNIT
20 COMPUTER
21 PROCESSOR
22 MEMORY
100 ATTACK KNOWLEDGE GENERATION APPARATUS
110 ATTACK INFORMATION ACQUISITION UNIT
120 INFORMATION EXTRACTION UNIT
121 Representation UNIT
122 Extraction UNIT
123 Derivation UNIT
130 SIMILARITY DETERMINATION UNIT
131 SPECIFYING UNIT
132 DETERMINATION UNIT
140 COMPLEMENTARY INFORMATION GENERATION UNIT
150 STORAGE UNIT
160 TRAINING UNIT
170 SIMILARITY DETERMINATION AND COMPLEMENTARY INFORMATION GENERATION UNIT
200 ATTACK INFORMATION DB
300 ATTACK KNOWLEDGE DB
400 ATTACK EXPERIMENT APPARATUS
401 ATTACK EXPERIMENT UNIT
402 INFORMATION CORRECTION UNIT
500 LEARNING APPARATUS

1. An attack information processing apparatus comprising:
a memory storing instructions, and
a processor configured to execute the instructions stored in the memory to;
extract first and second attack knowledge pieces indicating conditions of a cyber attack from first and second attack information pieces including descriptions of the cyber attack;
determine similarity between the first and second attack information pieces; and
the first attack knowledge piece with the second attack knowledge piece based on the determined similarity.

2. The attack information processing apparatus according to claim 1, wherein each of the first and second attack information pieces is vulnerability information in which a vulnerability of a computer system is described.

3. The attack information processing apparatus according to claim 1, wherein each of the first and second attack knowledge pieces includes a precondition and a result of a cyber attack.

4. The attack information processing apparatus according to claim 1, wherein the processor is further configured to execute the instructions stored in the memory to acquire distributed representation vectors of morphemes obtained by dividing sentences in the first and second attack information pieces and extract the first and second attack knowledge pieces based on the acquired distributed representation vectors.

5. The attack information processing apparatus according to claim 4, wherein the morpheme is one word or is composed of a plurality of words.

6. The attack information processing apparatus according to claim 4, wherein the processor is further configured to execute the instructions stored in the memory to assign labels related to the first and second attack knowledge pieces to the morphemes of which the distributed representation vectors have been acquired, and extract the first and second attack knowledge pieces based on the assigned labels.

7. The attack information processing apparatus according to claim 6, wherein the processor is further configured to execute the instructions stored in the memory to extract the first and second attack knowledge pieces based on a correspondence relation between the labels and conditions in the attack knowledge pieces.

8. The attack information processing apparatus according to claim 6, wherein the processor is further configured to execute the instructions stored in the memory to determine the similarity based on a difference of the distributed representation vector of each of the morphemes to which the labels have been assigned.

9. The attack information processing apparatus according to claim 8, wherein the processor is further configured to execute the instructions stored in the memory to determine the similarity based on an average value or a weighted average value of the differences of the distributed representation vectors.

10. The attack information processing apparatus according to claim 1, wherein the processor is further configured to execute the instructions stored in the memory to determine the similarity based on information of components included in the first and second attack information pieces.

11. The attack information processing apparatus according to claim 1, wherein the processor is further configured to execute the instructions stored in the memory to determine the similarity based on descriptions included in Descriptions of the first and second attack information pieces.

12. The attack information processing apparatus according to claim 1, wherein the processor is further configured to execute the instructions stored in the memory to determine the similarity based on reference information included the first and second attack information pieces.

13. The attack information processing apparatus according to claim 1, wherein the processor is further configured to execute the instructions stored in the memory to determine the similarity based on identification information of attack information included in the first and second attack information pieces.

14. The attack information processing apparatus according to claim 1, wherein the processor is further configured to execute the instructions stored in the memory to determine the similarity based on a degree of similarity between sentences in the first and second attack information pieces.

15. The attack information processing apparatus according to claim 14, wherein the degree of similarity is a degree of similarity based on a feature value including a frequency of appearances of a specific word, an order of appearances of a specific word, or statistical information thereof in the first and second attack information pieces.

16. The attack information processing apparatus according to claim 15, wherein the degree of similarity is a degree of similarity of a result of clustering of the feature values.

17. The attack information processing apparatus according to claim 14, wherein the processor is further configured to execute the instructions stored in the memory to determine the similarity based on a result of a comparison between the degree of similarity and a predetermined value.

18. The attack information processing apparatus according to claim 1, wherein the processor is further configured to execute the instructions stored in the memory to determine the similarity based on the extracted attack knowledge.

19. The attack information processing apparatus according to claim 18, wherein the processor is further configured to execute the instructions stored in the memory to determine the similarity based on a rate at which conditions included in the first and second attack knowledge pieces match each other.

20. The attack information processing apparatus according to claim 1, wherein the processor is further configured to execute the instructions stored in the memory to, when it is determined that the first and second attack information pieces are similar to each other, complement the first attack knowledge piece.

21. The attack information processing apparatus according to claim 1, wherein the processor is further configured to execute the instructions stored in the memory to complement the first attack knowledge piece according to a degree of similarity between the first and second attack information pieces.

22. The attack information processing apparatus according to claim 1, wherein the processor is further configured to execute the instructions stored in the memory to, when a condition included in the first attack knowledge piece conflicts with a condition included in the second attack knowledge piece, complement the first attack knowledge piece while giving a priority to a condition originally included in the first attack knowledge piece to be complemented.

23. The attack information processing apparatus according to claim 1, wherein the first attack information piece is an attack information piece to be analyzed, and the second attack information piece is included in predetermined attack information.

24. An attack information processing apparatus comprising:
a memory storing instructions, and
a processor configured to execute the instructions stored in the memory to;
extract a plurality of attack knowledge pieces indicating conditions of a cyber attack from a plurality of attack information pieces including descriptions of the cyber attack;
generate a learning model that has learned a relation between the plurality of attack information pieces and the plurality of attack knowledge pieces; and
complement an attack knowledge piece extracted from input attack information piece based on an attack information piece similar to the input attack information piece by using the learning model.

25. The attack information processing apparatus according to claim 1, wherein the processor is further configured to execute the instructions stored in the memory to:
construct an experiment environment based on a condition included in the complemented attack knowledge piece and carry out an experiment of the cyber attack in the experiment environment; and
correct the attack knowledge piece complemented based on a result of the experiment.

26. The attack information processing apparatus according to claim 25, wherein the processor is further configured to execute the instructions stored in the memory to generate a learning model that is used based on the result of the experiment by the extracting, the determining, or the complementing.

27. A method for processing attack information comprising:
extracting first and second attack knowledge pieces indicating conditions of a cyber attack from first and second attack information pieces including descriptions of the cyber attack;
determining similarity between the first and second attack information pieces; and
complementing the first attack knowledge piece with the second attack knowledge piece based on the determined similarity.

28. The method for processing attack information according to claim 27, wherein each of the first and second attack information pieces is vulnerability information in which a vulnerability of a computer system is described.

29. A non-transitory computer readable medium storing an attack information processing program for causing a computer to execute processes of:
extracting first and second attack knowledge pieces indicating conditions of a cyber attack from first and second attack information pieces including descriptions of the cyber attack;
determining similarity between the first and second attack information pieces; and
complementing the first attack knowledge piece with the second attack knowledge piece based on the determined similarity.

30. (canceled)
